(19) United States
(12) Patent Application Publication
(10) Pub. No.: US 2021/0159613 A1
(43) Pub. Date: May 27, 2021

(54) WIRE WITH TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hideki NOMURA, Mie (JP); Junichi ONO, Mie (JP); Takanobu SHIMADA, Mie (JP)

(21) Appl. No.: 17/054,223

(22) PCT Filed: May 16, 2019
(86) PCT No.: PCT/JP2019/019451

§ 371 Date: Nov. 10, 2020

(30) Foreign Application Priority Data
May 23, 2018 (JP) 2018-098480

(51) Int. Cl. H01R 4/18; H01R 13/11; H01R 43/048

(52) U.S. Cl. CPC H01R 4/184; H01R 43/048; H01R 13/114

(57) ABSTRACT

A wire with terminal is provided with a single core made of metal, and a terminal to be crimped to the single core. The terminal includes a base plate portion on which the single core is placed, and a pair of wire barrel portions (barrel portions) projecting upward from opposite side edges of the base plate portion. The pair of wire barrel portions (barrel portions) include a pair of side wall portions projecting upward from the opposite side edges of the base plate portion and a pair of folded pieces folded downwardly from upper ends of the pair of side wall portions. The pair of folded pieces respectively include first contact portions configured to contact the single core from above, second contact portions at positions above the first contact portions, and third contact portions configured to contact inner surfaces of the pair of side wall portions.

### TECHNICAL FIELD

A technique disclosed by this specification relates to a wire with terminal in which a terminal is crimped to a single core.

### BACKGROUND

A female terminal described in Japanese Patent Laid-Open Publication No. H08-037052 (Patent Document 1 below) is known as an example of a conventional terminal. This female terminal includes wire barrels to be crimped to a core made of a plurality of metal strands and insulation barrels to be crimped to an insulation coating covering the outer periphery of the core.

### PRIOR ART DOCUMENT

### Patent Document

Patent Document 1: JP H08-037052 A

### SUMMARY OF THE INVENTION

### Problems to be Solved

According to the above technique, with the wire barrels crimped to the core, tip parts of the wire barrels enter between the plurality of metal strands. In this way, contact surfaces where a pair of the wire barrels are in contact with each other are formed on parts of the pair of wire barrels near the tip parts. The opening of the pair of wire barrels is suppressed by a friction force generated on these contact surfaces. This is particularly effective when expansion at high temperatures and contraction at low temperatures repeat such as in a place where a temperature change is relatively large.

However, in the case of simply applying the above technique to a terminal to be crimped to a single core, the following problem may occur. In the case of crimping wire barrels to the single core, tip parts of the wire barrels are difficult to enter the single core. This is because a clearance into which the tip parts of the wire barrels enter is not present in the single core, unlike in the case that a core is made of a plurality of metal strands. Thus, contact surfaces where a pair of the wire barrels are in contact with each other may not be formed on parts of the pair of wire barrels near the tip parts or, even if the contact surfaces are formed, the contact surfaces may not have an area to generate a sufficient friction force.

In such a case, if the terminal is used in a place where a temperature change is relatively large, the pair of wire barrels expand in directions toward each other at high temperatures. On the other hand, at low temperatures, the pair of wire barrels contract in directions away from each other. Then, since the contact surfaces are originally not formed or do not have a sufficient area even if being formed, the pair of wire barrels may not be able to be held crimped to the single core by a friction force. As a result, there has been a problem that contact pressures between the single core and the wire barrels are reduced to increase contact resistance.

The technique disclosed in this specification was completed on the basis of the above situation and aims to provide a terminal which suppresses a reduction in contact pressure between a single core and wire barrels.

### Means to Solve the Problem

A wire with terminal disclosed in this specification is provided with a single core made of metal, and a terminal to be crimped to the single core, wherein the terminal includes a base plate portion, the single core being placed on the base plate portion, and a pair of barrel portions projecting upward from opposite side edges of the base plate portion and to be crimped to the single core, the pair of barrel portions include a pair of side wall portions projecting upward from the opposite side edges of the base plate portion and a pair of folded pieces folded downwardly from upper ends of the pair of side wall portions, and the pair of folded pieces respectively include first contact portions configured to contact the single core from above, second contact portions at positions above the first contact portions, the pair of folded pieces being in contact with each other at the second contact portions, and third contact portions configured to contact inner surfaces of the pair of side wall portions.

Since the pair of folded pieces are in contact at the second contact portions, the pair of barrel portions can be held in shape crimped to the single core by a friction force generated on the second contact portions.

Further, since the pair of barrel portions include the pair of side wall portions projecting upward and the pair of folded pieces folded downwardly, a direction of expansion or contraction of the pair of barrel portions due to a temperature change is a vertical direction. Thus, even if a temperature changes, the pair of barrel portions are suppressed from expanding or contracting in directions toward or away from each other. As a result, the pair of barrel portions are suppressed from expanding or contracting in directions to reduce areas of the second contact portions, wherefore the pair of barrel portions can be held in shape crimped to the single core.

Furthermore, since the pair of folded pieces and the pair of side wall portions are in contact at the third contact portions, the pair of folded pieces and the pair of side wall portions are suppressed from expanding or contracting due to a temperature change by friction forces generated on the third contact portions. In this way, the pair of barrel portions can be held in shape crimped to the single core.

Since the pair of barrel portions can be held in shape crimped to the single core in the above way, contact pressures of the barrel portions with the single core can be maintained and an increase in contact resistance between the barrel portions and the single core can be suppressed.

Further, a width W of the base plate portion in a direction orthogonal to an axial direction of the single core placed on the base plate portion may be set to be four times as large as a thickness T of the pair of side wall portions.

According to the above configuration, the pair of folded pieces are so crimped to the single core as to be accommodated between the pair of side wall portions, whereby a maximum of four metal plates constituting the barrel portions, extending in the vertical direction and having the thickness T are arranged side by side in a width direction within the range of the width W of the bottom plate portion. In this way, an increase in contact resistance between the barrel portions and the single core can be suppressed without enlarging the terminal.

Further, the width W of the base plate portion in the direction orthogonal to the axial direction of the single core placed on the base plate portion may be set equal to or smaller than six-fold of the thickness T of the pair of side wall portions.

Further, the pair of folded pieces may include a pair of first folded pieces folded downwardly from the upper ends of the pair of side wall portions and a pair of second folded pieces folded upwardly from lower end parts of the pair of first folded pieces and located between the pair of side wall portions and the pair of first folded pieces.

According to the above configurations, the pair of first folded pieces and the pair of second folded pieces are so crimped to the single core as to be accommodated between the pair of side wall portions, whereby a maximum of six metal plates constituting the barrel portions, extending in the vertical direction and having the thickness T are arranged side by side in the width direction within the range of the width W of the bottom plate portion. In this way, the pair of side wall portions, the pair of first folded pieces and the pair of second folded pieces are compressed with a strong force in the direction orthogonal to the axial direction of the single core placed on the bottom plate portion, and friction forces generated on the second and third contact portions can be increased. As a result, the pair of barrel portions can be held in shape crimped to the single core, wherefore contact pressures of the barrel portions with the single core can be maintained and an increase in contact resistance between the barrel portions and the single core can be suppressed.

### Effect of the Invention

According to the wire with terminal disclosed in this specification, it is possible to suppress a reduction in contact pressure between the single core and the barrel portions.

### BRIEF DESCRIPTION OF THE DRAWINGS

FIG. 1 is a view of a single core wire and a terminal.

FIG. 2 is a section of wire barrel portions before crimping in a first embodiment.

FIG. 3 is a section of the wire barrel portions after crimping in the first embodiment.

FIG. 4 is a section of wire barrel portions after crimping in a second embodiment.

### DETAILED DESCRIPTION TO EXECUTE THE INVENTION

### First Embodiment

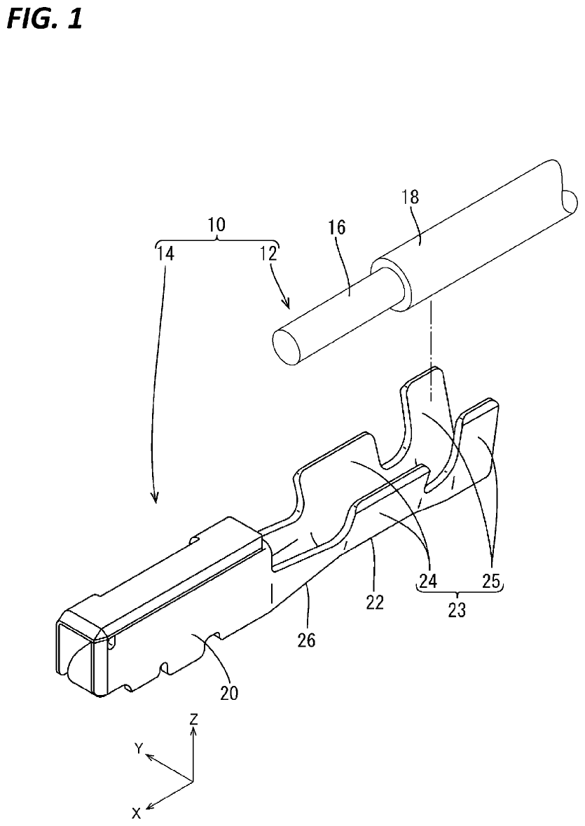

A first embodiment is described with reference to FIGS. 1 to 3. In the following description, an X direction, a Y direction and a Z direction of FIGS. 1 to 3 are referred to as a forward direction, a rightward direction and an upward direction.

A wire with terminal 10 of this embodiment includes a single core wire 12 and a terminal 14 to be crimped to the single core wire 12 as shown in FIG. 1.

The single core wire 12 is composed of a single core 16 made of copper alloy and an insulation coating 18 covering the single core 16, and the coating is striped on a tip part of the single core wire 12 to expose the single core 16. Here, the single core 16 is a core having a very small diameter (e.g. having a cross-sectional area of 0.05 mm²).

The terminal 14 is a female terminal and formed by press-working and bending a sheet metal made of copper alloy and includes a box-shaped body portion 20 into which a mating male terminal (not shown) is fit, a plate-like bottom plate portion 22 which is provided behind the body portion 20 and on which the single core wire 12 is placed, a crimping portion 23 which is to be crimped to the single core wire 12, and a coupling portion 26 which couples the body portion 20 and the bottom plate portion 22.

The crimping portion 23 is composed of a pair of wire barrel portions (barrel portions) 24 projecting upward from opposite end edges of the bottom plate portion 22 and to be crimped to the tip part of the single core 16, and a pair of insulation barrel portions 25 disposed behind the wire barrel portions 24 and to be crimped to the insulation coating 18.

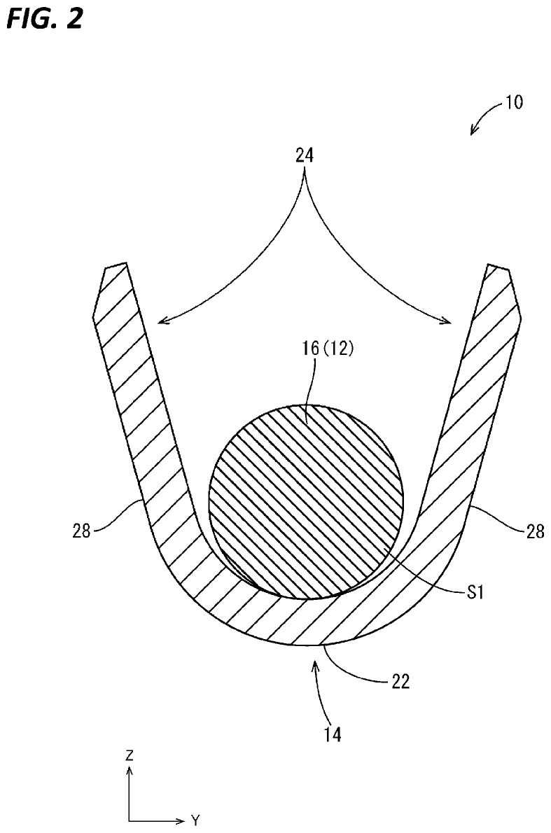

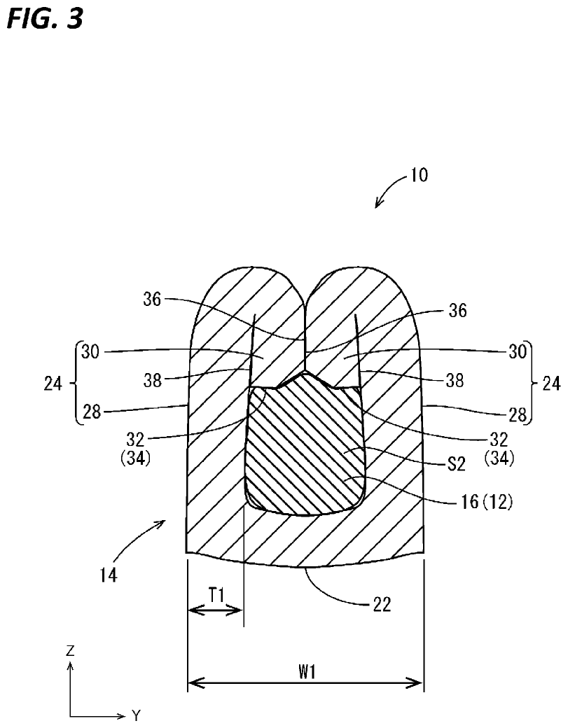

The pair of wire barrel portions 24 are in the form of an open barrel and include a pair of side wall portions 28 projecting upward from the opposite side edges of the bottom plate portion 22 as shown in FIG. 2. In crimping the pair of wire barrel portions 24 to the single core 16, the pair of side wall portions 28 are folded downwardly from upper ends as shown in FIG. 3 by a crimping machine, and the single core 16 is pressed from above by a pair of folded pieces 30 formed in this way. Further, the pair of side wall portions 28 are displaced inward by the crimping machine and the single core 16 is pressed from both lateral sides by the pair of side wall portions 28. In the above way, the pair of wire barrel portions 24 are crimped to the single core 16. A ratio S2/S1 of a cross-sectional area S2 of the single core 16 after crimping to a cross-sectional area S1 of the single core 16 before crimping is about 0.8 to 0.9.

With the pair of wire barrel portions 24 crimped to the single core 16, tip edges 32 of the pair of folded pieces 30 are in contact with the single core 16 from above and serve as first contact portions 34.

Further, surfaces of the pair of folded pieces 30 facing each other are in contact with each other and serve as second contact portions 36. At this time, since the pair of folded pieces 30 are folded downwardly from above, the second contact portions 36 are also formed to extend in a vertical direction.

Further, surfaces of the pair of folded pieces 30 opposite to the second contact portions 36 are respectively in contact with the inner surfaces of the opposing side wall portions 28 and serves as third contact portions 38. At this time, the third contact portions 38 are located near tip parts of the pair of folded pieces 30 (i.e. on the side of the tip edges 32 of the pair of folded pieces 30).

With the pair of wire barrel portions 24 crimped to the single core 16, the pair of folded pieces 30 are accommodated between the pair of side wall portions 28 and a lateral width W1 of the bottom plate portion 22 is about four times as large as a thickness T1 of the pair of side wall portions 28. Since crimping is performed such that two side wall portions 28 constituting the wire barrel portions 24 and two folded pieces 30 are arranged side by side within the range of the width W1 in this way, an enlargement of the terminal 14 in a width direction is suppressed.

Next, functions of this embodiment are described.

If the wire with terminal 10 is placed in a high temperature environment, the single core 16 thermally expands, whereby the wire barrel portions 24 are pushed upward. However, the respective folded pieces 30 of the pair of wire barrel portions 24 are held in contact with each other at the second contact portions 36 and the pair of folded pieces 30 are respectively in contact with the pair of side wall portions 28 at the third contact portions 38. Thus, upward displacements of the pair of wire barrel portions 24 are suppressed by friction forces generated on the second and third contact portions 36, 38. Particularly, since the second contact portions 36 are formed to be long in the vertical direction as described above, the friction force generated on the second contact portions 36 is large as compared to a configuration in which only tip parts of barrels are in contact as before. In the above way, the pair of wire barrel portions 24 are suppressed from being pushed up by the thermal expansion of the single core 16.

Further, the thermally expanded single core 16 contracts and the pair of wire barrel portions 24 are going to be displaced downward when a return is made to a normal temperature environment from the high temperature environment. However, downward displacements of the pair of wire barrel portions 24 are restricted by friction forces generated on the second and third contact portions 36, 38.

As just described, since a direction of displacement of the pair of wire barrel portions 24 is the vertical direction when the single core 16 expands or contracts due to a temperature change, the pair of wire barrel portions 24 are suppressed from expanding or contracting in directions toward or away from each other (lateral directions). As a result, the pair of wire barrel portions 24 are suppressed from being displaced in directions to reduce contact areas of the second and third contact portions 36, 38. Thus, a state where the pair of wire barrel portions 24 are crimped to the single core 16 can be held, contact pressures of the wire barrel portions 24 with the single core 16 can be maintained, and an increase in contact resistance between the wire barrel portions 24 and the single core 16 can be suppressed.

As described above, since the pair of folded pieces 30 are in contact at the second contact portions 36 according to this embodiment, the pair of wire barrel portions (barrel portions) 24 can be held in shape crimped to the single core 16 by a friction force generated on the second contact portions 36.

Further, since the pair of wire barrel portions (barrel portions) 24 include the pair of side wall portions 28 projecting upward and the pair of folded pieces 30 folded downwardly, the direction of expansion or contraction of the pair of wire barrel portions (barrel portions) 24 due to a temperature change is the vertical direction. Thus, even if a temperature changes, the pair of wire barrel portions (barrel portions) 24 are suppressed from expanding or contracting in the directions toward or away from each other. As a result, the pair of wire barrel portions (barrel portions) 24 are suppressed from expanding or contracting in directions to reduce the areas of the second contact portions 36, wherefore the pair of wire barrel portions (barrel portions) 24 can be held in shape crimped to the single core 16.

Furthermore, since the pair of folded pieces 30 and the pair of side wall portions 28 are in contact at the third contact portions 38, the pair of folded pieces 30 and the pair of side wall portions 28 are suppressed from expanding or contracting due to a temperature change by friction forces generated on the third contact portions 38. In this way, the pair of wire barrel portions (barrel portions) 24 can be held in shape crimped to the single core 16.

Since the pair of wire barrel portions (barrel portions) 24 can be held in shape crimped to the single core 16 in the above way, the contact pressures of the pair of wire barrel portions (barrel portions) 24 with the single core 16 can be maintained and an increase in contact resistance between the pair of wire barrel portions (barrel portions) 24 and the single core 16 can be suppressed.

Further, the pair of folded pieces 30 are so crimped to the single core 16 as to be accommodated between the pair of side wall portions 28, whereby a maximum of four metal plates constituting the pair of wire barrel portions (barrel portions) 24, extending in the vertical direction and having the thickness T1 are arranged side by side in the width direction within the range of the width W1 of the bottom plate portion 22. In this way, an increase in contact resistance between the pair of wire barrel portions (barrel portions) 24 and the single core 16 can be suppressed without enlarging the terminal 14.

### Second Embodiment

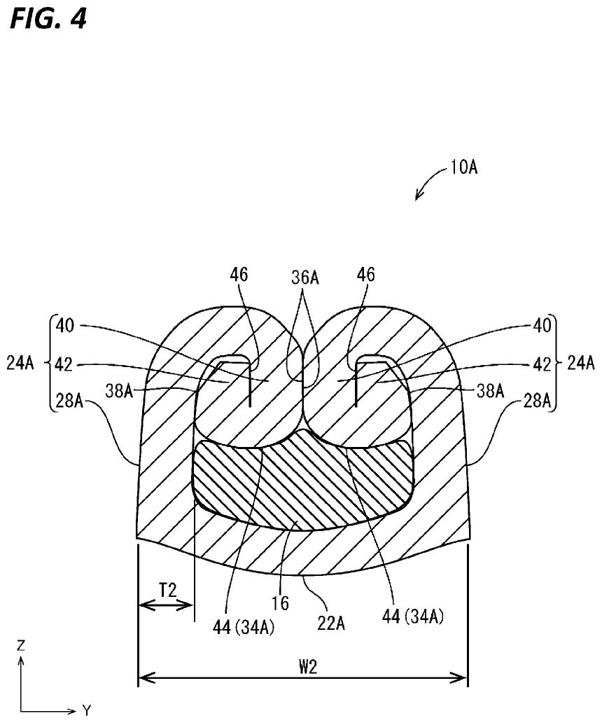

A wire with terminal 10A of a second embodiment is described with reference to FIG. 4.

Although the pair of side wall portions 28 are folded downwardly once in crimping the pair of wire barrel portions 24 to the single core 16 in the first embodiment, a pair of side wall portions 28A are folded downwardly once and the tips of folded parts are folded upwardly once in crimping a pair of wire barrel portions 24A to a single core 16. The other configuration is the same as in the first embodiment.

In crimping the pair of wire barrel portions 24A to the single core 16, the pair of side wall portions 28A are folded downwardly from upper ends, whereby a pair of first folded pieces 40 are formed. If being further pressed against the single core 16, the tips of the pair of first folded pieces 40 are folded upwardly by reaction forces generated when the tips of the pair of first folded pieces 40 are pressed against the single core 16 without entering the single core, whereby a pair of second folded pieces 42 are formed. The pair of second folded pieces 42 are folded upwardly via a pair of folded base end portions 44 connected to lower end parts of the pair of first folded pieces 40 and located between the pair of side wall portions 28 and the pair of first folded pieces 40.

With the pair of wire barrel portions 24A crimped to the single core 16, the folded base end portions 44 of the second folded pieces 42 serve as first contact portions 34A configured to contact the single core 16 from above. Further, surfaces of the pair of first folded pieces 40 facing each other serve as second contact portions 36A configured to contact each other. At this time, the second contact portions 36A are located above the first contact portions 34A. Further, out of the pair of second folded pieces 42, parts configured to contact the pair of side wall portions 28 serve as third contact portions 38A. At this time, the third contact portions 38A are located near tip parts of the second folded pieces 42 (i.e. upper end sides of the pair of second folded pieces 42). Further, out of the pair of second folded pieces 42, parts configured to contact the pair of first folded pieces 40 serve as fourth contact portions 46.

With the pair of wire barrel portions 24A crimped to the single core 16, the pair of first folded pieces 40 and the pair of second folded pieces 42 are accommodated between the pair of side wall portions 28A, and a lateral width W2 of a bottom plate portion 22A is about six times as large as a thickness T2 of the pair of side wall portions 28A. Since crimping is performed such that two side wall portions 28, two first folded pieces 40 and two second folded pieces 42 are arranged side by side within the range of the width W2 of the bottom plate portion 22A in this way, the pair of side wall portions 28, the pair of first folded pieces 40 and the pair of second folded pieces 42 are compressed with a strong force and friction forces generated on the second and third contact portions 36A, 38A can be made larger than in the configuration of the first embodiment. As a result, the pair of wire barrel portions 24A can be held in shape crimped to the single core 16, wherefore contact pressures of the wire barrel portions 24 with the single core 16 can be maintained and an increase in contact resistance between the wire barrel portions 24 and the single core 16 can be suppressed.

As described above, according to this embodiment, the pair of first folded pieces 40 and the pair of second folded pieces 42 are so crimped to the single core 16 as to be accommodated between the pair of side wall portions 28, whereby a maximum of six metal plates constituting the barrel portions, extending in the vertical direction and having the thickness T2 are arranged side by side in the width direction within the range of the width W2 of the bottom plate portion 22. In this way, the pair of side wall portions 28, the pair of first folded pieces 40 and the pair of second folded pieces 42 are compressed with a strong force in a direction orthogonal to an axial direction of the single core 16 placed on the bottom plate portion 22, and friction forces generated on the second and third contact portions 36, 38 can be increased. As a result, the pair of wire barrel portions (barrel portions) 24 can be held in shape crimped to the single core 16, wherefore the contact pressures of the pair of wire barrel portions (barrel portions) 24 with the single core 16 can be maintained and an increase in contact resistance between the pair of wire barrel portions (barrel portions) 24 and the single core 16 can be suppressed.

### Other Embodiments

The technique disclosed in this specification is not limited to the above described and illustrated embodiments. For example, the following various modes are also included.

(1) Although the terminal 14 is a female terminal in the above embodiments, application to a male terminal is also possible.

(2) Although the single core 16 has a very small diameter in the above embodiments, application to a single core having a general diameter (e.g. having a cross-sectional area of about 0.5 mm²) is also possible.

(3) Although the single core wire 12 includes the insulation coating 18 in the above embodiments, a bare wire not including the insulation coating 18 may be used.

### LIST OF REFERENCE NUMERALS

10, 10A: wire with terminal
14: terminal
16: single core
22, 22A: bottom plate portion
24, 24A: wire barrel portion (barrel portion)
28, 28A: side wall portion
30: folded piece
32: tip edge
34, 34A: first contact portion
36, 36A: second contact portion
38, 38A: third contact portion
40: first folded piece
42: second folded piece
44: folded base end portion
W1: width
T1: thickness
W2: width
T2: thickness

What is claimed is:

1. A wire with terminal, comprising:
a single core; and
a terminal to be crimped to the single core,
wherein:
the terminal includes a base plate portion, the single core being placed on the base plate portion, and a pair of barrel portions projecting upward from opposite side edges of the base plate portion and to be crimped to the single core,
the pair of barrel portions include a pair of side wall portions projecting upward from the opposite side edges of the base plate portion and a pair of folded pieces folded downwardly from upper ends of the pair of side wall portions, and
the pair of folded pieces respectively include first contact portions configured to contact the single core from above, second contact portions at positions above the first contact portions, the pair of folded pieces being in contact with each other at the second contact portions, and third contact portions configured to contact inner surfaces of the pair of side wall portions.

2. The wire with terminal according to claim 1, wherein a width W of the base plate portion in a direction orthogonal to an axial direction of the single core placed on the base plate portion is set to be four times as large as a thickness T of the pair of side wall portions.

3. The wire with terminal according to claim 1, wherein a width W of the base plate portion in a direction orthogonal to an axial direction of the single core placed on the base plate portion is set equal to or smaller than six-fold of a thickness T of the pair of side wall portions.

4. The wire with terminal according to claim 1 or 3, wherein the pair of folded pieces include a pair of first folded pieces folded downwardly from the upper ends of the pair of side wall portions and a pair of second folded pieces folded upwardly from lower end parts of the pair of first folded pieces and located between the pair of side wall portions and the pair of first folded pieces.
